(19) United States
(12) Patent Application Publication
(10) Pub. No.: US 2012/0030707 A1
(43) Pub. Date: Feb. 2, 2012

(54) Methods and Arrangements for Channel Change in an IPTV Network

(75) Inventors: Mats Cedervall, Hamosand (SE); Fredrik Persson, Alvsjo (SE)

(73) Assignee: TELEFONAKTIEBOLAGET LM ERICSSON (PUBL), Stockholm (SE)

(21) Appl. No.: 13/262,016

(22) PCT Filed: Nov. 23, 2009
(86) PCT No.: PCT/SE09/51318

§ 371 Date: Sep. 30, 2011

Related U.S. Application Data
(60) Provisional application No. 61/165,073, filed on Mar. 31, 2009.

(51) Int. Cl. H04N 21/40; H04N 21/20

(52) U.S. Cl. 725/38

(57) ABSTRACT

The present invention relates to methods and arrangements for providing an improved channel change solution for and IPTV system. This is achieved by sending an additional FCC (Fast Channel Change) media stream using multicast from a fast channel change server. The FCC media stream contains a stream being a copy of the main stream wherein the speed is higher than the speed of the main stream. The FCC media stream may start with an I or S-frame and a number of STBs can use the same FCC multicast stream.

### TECHNICAL FIELD

The present invention relates to provision of broadcasted TV services over an IP network, and in particular to fast channel changes.

### BACKGROUND

IPTV (Internet Protocol TV) is a term used when delivering broadcasted TV services over an IP network, typically a broadband access network. Currently the predominant IPTV service is Broadcast TV, in which the normal non-IPTV channels, as well as additional channels with low penetration are transmitted over the broadband network from the super head-end down to the end-user's set top box (STB). In order to minimize the bandwidth required for these transmissions it is desirable to use multicast techniques through the network. When the user switches from one channel to another, the STB then sends out IGMP (Internet Group Management Protocol) messages to leave the current channel and to join the new channel. In IGMP version 3 this is done in the same IGMP message, and in previous versions of IGMP the leave and join are sent in two separate IGMP messages.

The multicast group that the STB joins contains streams with MPEG (normally MPEG-2 or MPEG-4 part 10) frames. In MPEG three types of frames are provided; so-called I-frames which contain a full picture, P-frames which contain incremental extrapolation information, and B-frames which contain interpolation information. Since B and P frames depend on adjacent frames it is necessary that the STB receives a full I-frame before a new channel can be shown. This means that the average time for switching between channels will depend on the distance in time between I-frames. Typically for MPEG-2 the distance in time is around 0.5 seconds and for mpeg-4 part 10 it can be up to several seconds.

Other sources of delay include the buffer in the STB and network equipment, the time it takes for the IGMP leave/join procedure and other processing time.

In order to alleviate the problem with channel switching delay there are various solutions existing today.

In prior art solutions e.g. as described in US2005/0081244 A1, a unicast session for a requested channel is started to get the frames down as fast as possible when a change to the channel is requested and then the unicast session is switched over to a multicast session when a synchronization between the unicast stream and the multicast stream is achieved.

One major problem with the unicast based switch type of solution as disclosed in e.g. US2005/0081244 A1 is that it will result in a substantial bandwidth increase in the network due to that one unicast stream is transmitted for each channel change. Therefore, the channel change switch will either have to be close to, or inside the access node to reduce the required network bandwidth. Other prior art solutions have a similar problem that with frequent channel changes there will be massive amounts of unicast requests, which lead to difficult and expensive scalability.

The unicast solution also has a few additional drawbacks. Firstly it assumes that the available bandwidth on the last mile (e.g. on the Digital Subscriber Line (DSL)) is quite high, since it is necessary to download both unicast and multicast data concurrently, at least for a short while. In addition the solution has a scalability problem. Consider e.g. the case when a very popular program ends and a large number of people are starting to zap simultaneously, then it is not feasible to start unicast session to all those users unless the number of servers handling the unicast sessions is very large. Yet another drawback is that the STB needs to implement this functionality, which can be quite complex.

However, the solution in WO 2008/041896 solves the unicast scalability problem. The basic concept is that the P-frames are converted into I-frames (S-frames) at the head-end level. These I-frames together with the original I-frames are then sent in an auxiliary multicast channel. The STB joins the auxiliary multicast stream to obtain an I-frame faster to avoid waiting for the next I-frame in the main multicast stream containing the usual I-, P- and B-frames. When the STB switches channels it joins first the auxiliary multicast channel with the I-frames and slightly later it joins the normal channel. The STB will then be provided with a recent I-frame, and when the next P-frame in the normal multicast channel arrives it can calculate a full picture.

### SUMMARY

The object of the present invention is to provide an improved channel change solution for an IPTV system.

This is achieved by sending an additional FCC (Fast Channel Change) media stream using multicast from a fast channel change server. The FCC media stream contains a stream being a copy of the main stream wherein the speed is higher than the speed of the main stream. The FCC media stream may start with an I or S-frame and a number of STBs can use the same FCC multicast stream.

The FCC media stream sent via multicast can be created dynamically when enough STBs have requested channel change, or statistically using average FCCs per second, or statically, using the same number of channels. The FCC media stream is sent faster than real time in order to fill the buffer, e.g. 120%. The bitrate of the FCC information can be adapted to not to go above a threshold (e.g. 5 mbits for SD (standard definition). After receiving the FCC media stream for a while, the STB will switch to the original TV channel stream. The multicast channel used for the FCC media stream is reused for future time periods.

According to a first aspect of the present invention, a method in a FCC server adapted to manage fast channel change to a first multicast channel requested by STB in an IPTV system is provided. In the method, it is determined to send out at least one FCC media stream multicast channel wherein each FCC media stream multicast channel of the at least one FCC media stream multicast channel is a copy of a first media stream of the first channel and each FCC media stream multicast channel is having a higher speed than the first multicast channel. The determined at least one FCC media stream multicast channel is provided and information is sent to the STB which FCC media stream multicast channel that the STB shall join to be provided with the content of the first multicast channel.

According to a second aspect of the present invention, a method in a STB for a fast channel change in an IPTV system is provided. In the method it is determined that a change to a first multicast channel is requested. The first multicast channel is requested and information is received of which FCC media stream multicast channel that the STB shall join to be provided with the content of the first multicast channel. Finally, the STB joins the FCC media stream multicast channel.

According to a third aspect of the present invention a FCC server adapted to manage fast channel change to a first multicast channel requested by a STB in an IPTV system is provided. The FCC server comprises a multicast channel generator for determining to send out at least one FCC media stream multicast channel, wherein each FCC media stream multicast channel of the at least one FCC media stream multicast channel is a copy of a first media stream of the first channel and each FCC media stream multicast channel is having a higher speed than the first multicast channel. The multicast channel generator is further adapted to provide the determined at least one FCC media stream multicast channel. The FCC server further comprises a transmitter for sending information to the STB which FCC media stream multicast channel that the STB shall join to be provided with the content of the first multicast channel.

According to a fourth aspect of the present invention, a STB for a fast channel change in an IPTV system is provided. The STB comprises a channel change handler for determining that a change to a first multicast channel is requested and a transmitter for requesting the first multicast channel. The STB further comprises a receiver for receiving information of which FCC media stream multicast channel that the STB shall join to be provided with the content of the first multicast channel, and a channel change manager for joining the FCC media stream multicast channel.

An advantage with embodiments of the present invention is that they provide a solution for fast channel switching, which poses no requirement on the access network, except for some extra required bandwidth, and which does not introduce any extra functionality apart from the head-end level encoders.

A further advantage is that, unlike other fast channel change solutions, the embodiments of the present are scalable without significant server side costs. In addition they do not cause any permanent significant delay of the TV channel for the user.

### BRIEF DESCRIPTION OF THE DRAWINGS

FIG. 1 illustrates an IPTV network wherein the embodiments of the present invention may be implemented.

FIG. 2 illustrates a typical sequence of frames according to prior art.

FIGS. 3, 4 and 6 are flowcharts of the methods according to embodiments of the present invention.

FIGS. 5, 7 and 8 are sequence diagrams of the methods according to embodiments of the present invention.

FIG. 9 illustrates how the FCC media stream channels are constructed according to embodiments of the present invention.

FIGS. 10 and 11 illustrate how the FCC media streams are displaced compared to the original multicast channel according to embodiments of the present invention.

FIG. 12 illustrates a FCC server and a STB according to embodiments of the present invention.

### DETAILED DESCRIPTION

The present invention will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements.

Moreover, those skilled in the art will appreciate that the means and functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

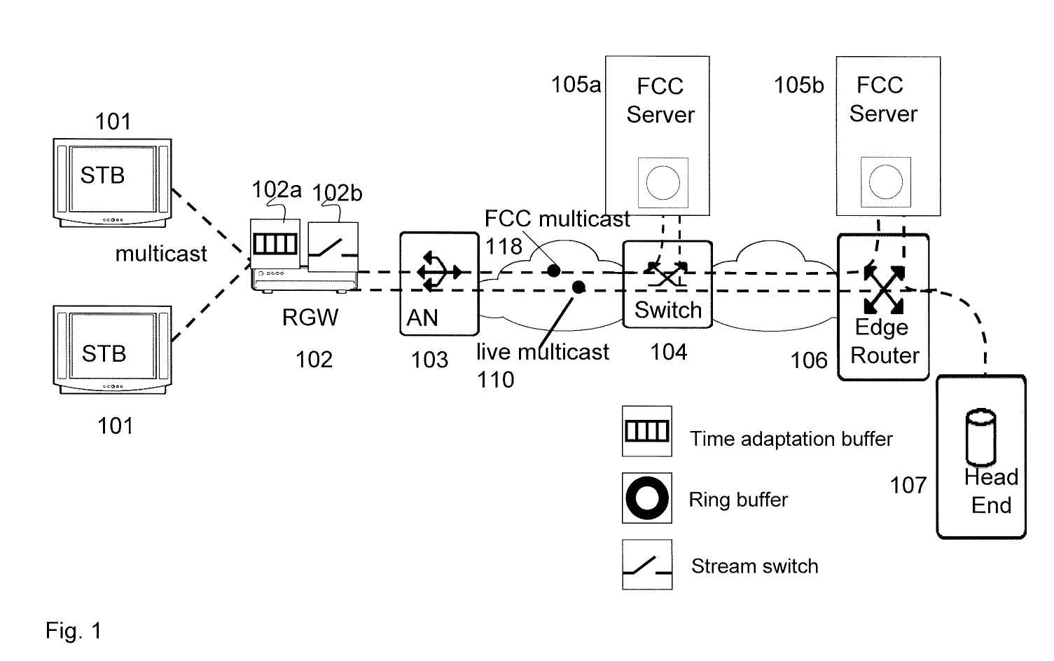

FIG. 1 gives an overview of an IPTV architecture 100 to which the embodiments of the present invention relates. Multicast streams 110 are transmitted from a head end server 107 to the STBs 101. The multicast stream 110 is transmitted via routers 106, switches 104, an access node 103 and a residential gateway 102 to the STBs 101.

The access node 103 is the last node in the operator's network. In case of a Digital Subscriber Line (DSL) network, the access node 103 is a DSLAM.

Fast channel change (FCC) servers 105a, 105b are provided to manage fast channel changes. The FCC Servers 105a, 105b are normally placed close to the Head-end 107 but they can be located in many levels of the network in order to save network bandwidth. If the FCC Server 105a, 105b is placed close to the access node 103 more server capacity is required whereas if the FCC server 105a, 105b is closer to the Head-end 107 more network bandwidth is required. The location of the FCC server is hence a tradeoff between bandwidth cost and server cost.

The set-top box (STB) 101 is the device that terminates the IPTV multicast streams and the residential gateway (RGW) 102 is a gateway used to connect devices, e.g. the STB, in the home to e.g. the Internet. It should also be noted that the buffer 102a and the switch 102b do not have to reside in the STB as illustrated, they can instead be located in the RGW.

The switches 104 and routers 106 may be standard equipment supporting multicast, including IGMP.

The embodiments of the present invention provide a solution for fast channel change to multicast channels.

In MPEG there are different frames, so-called I-frames which contain a full picture, P-frames contain incremental extrapolation information, and B-frames contain interpolation information. S-frames are P-frames that have been converted into I-frames. Since B and P frames depend on adjacent frames it is necessary that the STB receives an I-frame before a new channel can be shown. I-frames, or Intra frames are usually called IDR frames in the case of MPEG-4 part 10, but the principle is the same.

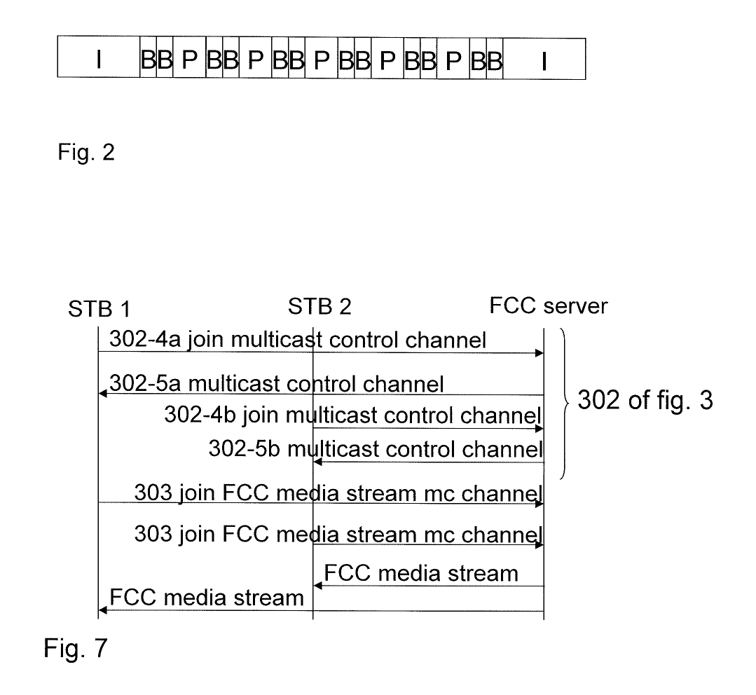

FIG. 2 illustrates a typical sequence of frames. The frame sequence is not the order they are transmitted, but rather the order they are displayed.

The size of the different frames illustrates the fact that I-frames are larger than P-frames, which in turn are larger than B-frames. The relative size in FIG. 2 is only for illustrative purposes, in practice the difference in size is even larger. The I-frame plus the frames between two I-frames are called Group Of Pictures, or GOP. The GOP in the above example is 19, but GOP can be significantly larger. Without an efficient FCC solution a large GOP leads to longer average channel switching times.

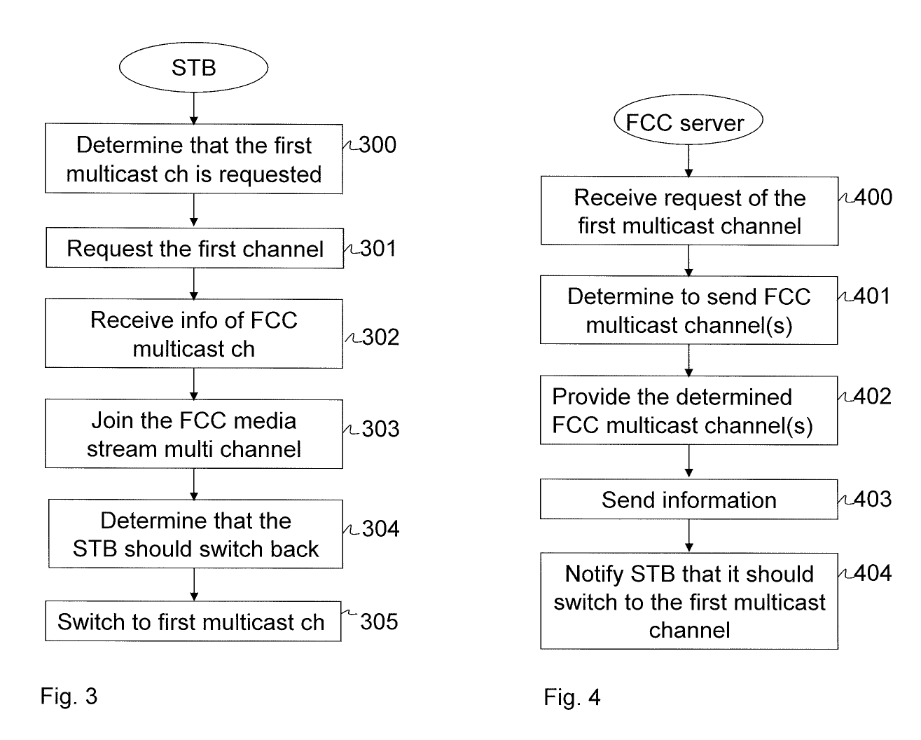

The basic idea with the present invention is to provide FCC media stream multicast channels, wherein each FCC media stream multicast channel is a copy of a media stream of the requested multicast channel and each FCC media stream multicast channel is having a higher speed than the requested multicast channel. The fast channel change solution according to embodiments of the present invention comprises the following steps as illustrated in the flowcharts of FIGS. 3 and 4.

In step 300, a channel change event takes place in the STB, e.g. because the user zaps or selects a new channel e.g. from an enhanced program guide (EPG) and the STB determines that a new multicast channel is requested accordingly. Then, the STB requests 301 the new multicast channel, referred to as the first multicast channel. The request may be sent to the FCC server or to another entity in the IP network. The STB receives 302 information from the FCC server which FCC media stream multicast channel to join, e.g. the multicast address to the FCC media stream multicast channel. The STB joins 303 the FCC media stream multicast channel and the STB starts to fill buffer with the FCC media stream multicast channel.

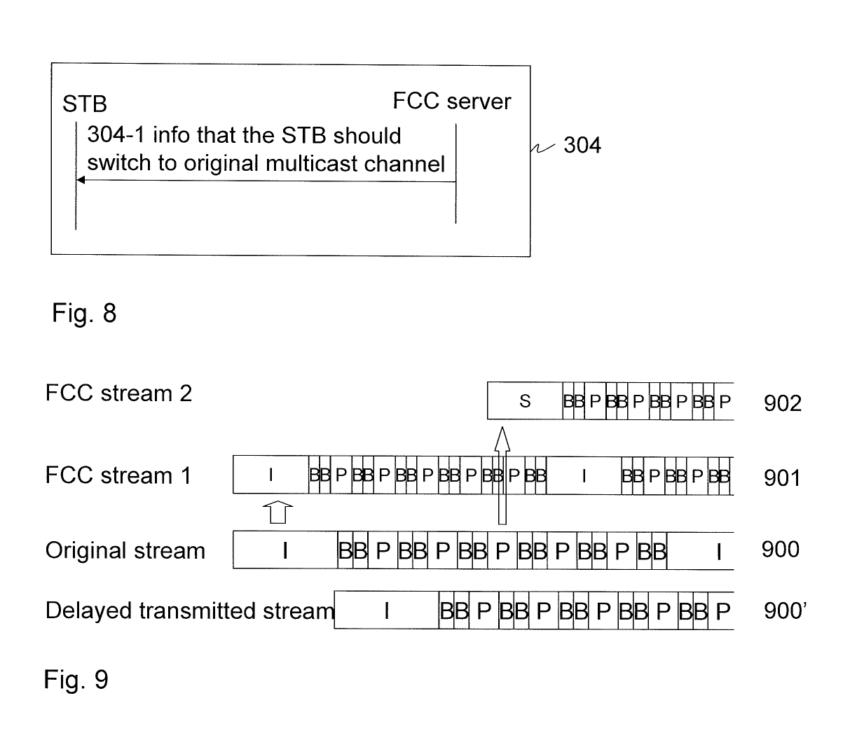

The FCC media stream always starts with an I-frame and when the first I-Frame is received the STB decodes said FCC media stream multicast channel and starts to display video/audio. Later, the STB determines that it should switch back from said FCC media stream multicast channel to the original multicast channel by receiving a notification 304-1 (FIG. 8) or the STB may figure that out itself without the notification.

When the STB has switched back, the STB synchronizes 305 the frames of said FCC media stream multicast channel with the frames of said first multicast channel.

Turning now to FIG. 4, the FCC server determines 401 to send out at least one FCC media stream multicast channel and e.g. also when in time the at least one FCC media stream multicast channel should be sent. According to one embodiment that is determined in response to a received request 400 of the first multicast channel. However, the STB may know by other means than asking the FCC server what FCC channel it should join, e.g. this information may be received on a multicast channel.

The at least one FCC media stream multicast channel is provided 402 (generated by the FCC server or forwarded by the FCC server) and the FCC server sends 403 information to the STB of which FCC media stream multicast channel to join. Later, the FCC server may notify 404 the STB that it should switch to the first multicast channel, i.e. the original multicast channel.

According to embodiments of the present invention a multicast control channel may be provided. The multicast control channel may be used to send information of which FCC media stream multicast channel to join.

It should be noted that the request step 301 of FIG. 3 corresponds to the receive request step 400 of FIG. 4, step 302 corresponds to step 403, and steps 304 and 304-1 of FIG. 3 correspond to step 404 of FIG. 4.

FIG. 7 illustrates the multicast control channel and the FCC media streams that two STBs, STB 1, and STB 2 utilize.

In step 302-4a, a first STB sends a join multicast control channel to the FCC server and the FCC server replies with distributing the multicast control channel in step 302-5a.

In a subsequent step 302-4b, a second STB sends a join multicast control channel to the FCC server and the FCC server replies with distributing the multicast control channel in step 302-5b. The first and second STBs receive 302 information on the multicast control channel of which FCC media stream multicast channel to join, e.g. by the multicast address, e.g. in response to a request for that information. In a further step 303, the first and second STBs send a join FCC media stream multicast channel to the multicast address indicated on the multicast control channel. The FCC server responds by distributing the FCC media stream.

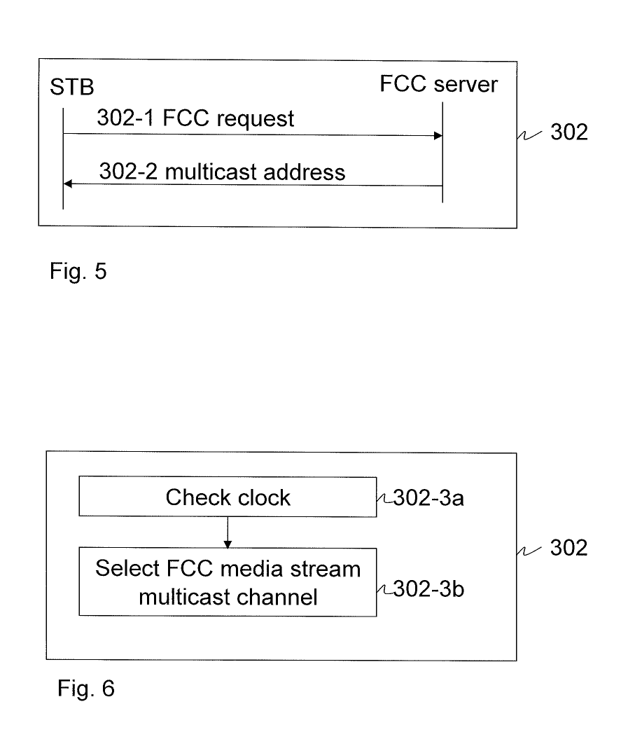

Thus one way to find out which FCC media stream multicast channel to join is illustrated in FIG. 5. The STB requests 302-1a multicast channel and is provided 302-2 with the multicast address to the FCC media stream multicast channel which is a copy of the requested multicast channel but transmitted with a higher speed. As illustrated in FIG. 7 in steps 302-5a,b the multicast address may be sent on the multicast control channel.

Another way to find out which FCC media stream multicast channel to join is illustrated in FIG. 6, where the use of FCC media multicast channels is configured statically, e.g. according to a clock. The FCC media stream multicast channels can be displaced in time according to a fixed scheme, relative to some time constant. E.g. at join channel channelLookup(mod((time−Tconst)/y,x)).

According to a third alternative, this is achieved by multicast control channel. Information about which multicast channel contains the next FCC media stream is transmitted on a separate multicast group. The STB joins this multicast control channel when it needs information about the FCC media streams. When a channel switching command comes from the user for a particular channel, the STB uses information from the multicast control channel to find out what FCC media stream multicast channel to join.

The FCC server needs to decide how many FCC media channels are required, and when in time they are transmitted. This decision can be dynamically calculated or be a static fixed known configuration.

There are several ways for the server to make a dynamic decision, however, they all require that the STB finds out which FCC media stream multicast channel to join according to the first or third alternative.

According to one embodiment, the FCC server provides the FCC media stream multicast channels at regular intervals compared e.g. to the previous I-frame, e.g. Every second P-frame. The length of the intervals may be dependent on the number of users watching the channel. This information may be determined based on dynamic channel statistics, e.g. retrieved from a stand-alone system, and is not part of this invention.

According to another embodiment, the FCC server provides the FCC media stream multicast channels dynamically, e.g. when a predefined number requests have been sent by the STBs. The STBs may send the requests to the FCC server, or the FCC server may be provided with information of the number of requests sent from the STBs e.g. by means of SIP messages. Thus when the FCC server has determined that the predefined number of requests for a certain channel is requested by the STBs, the FCC server will send information to the STBs of what FCC media stream to join, and shortly thereafter it will start to transmit on that multicast channel.

A yet further embodiment is a sub-case to the embodiment of dynamically provided FCC media stream multicast channels. In this embodiment the maximum delay is limited. As long as there is at least one STB that has joined said FCC media stream multicast channel and the time since the last FCC media stream multicast channel is provided is larger than a predetermined time period, the FCC server will provide a new FCC media stream multicast channel.

A yet further alternative is that the FCC media stream multicast channel is only provided if at least one STB has joined said multicast control channel. If no STB switches to the multicast control channel no bandwidth will be used for the FCC media stream multicast channel.

FIG. 9 illustrates further how the FCC media stream channels are constructed.

The FCC media stream channels are constructed from the original TV channel 900 (referred to as the first multicast channel) but with a higher speed than the original TV channel. The FCC media stream channels 901, 902 may be a transcoded and time-forwarded version of the transmitted original TV Channel. Hence the STB can fill the buffer at the same time its start to display the video/audio. The FCC media stream need to arrive before the normal frames and therefore the original TV channel 901′ need to be delayed in time before it is being sent out. This is the same as for unicast-based methods according to prior art. However in the embodiments of the present invention a fairly small delay is sufficient, primarily in order to allow for the IGMP switching time when going back to the original TV channel.

The FCC media stream can start either with an I-frame or an S-frame. The advantage with using only I-frames is that costly transcoding does not have to be performed. However, the FCC media stream has to be active for a longer time.

The FCC media stream will only exist during the time the FCC media stream multicast channel is needed for the STBs to catch up to with the original multicast channel, before the original stream which is delayed in time. Then it will either terminate directly or continue for the while as an exact copy, but not as a delayed version, of the original channel stream but of course without the speedup. The multicast channel used will be reused of another FCC media stream.

In step 304, the STB needs to find out when it should change back to the original TV channel stream. This requires that the FCC media stream have transmitted all frames that also have been transmitted on the original TV channel stream, and also some future frames in order to allow for IGMP switching delay (future in comparison to the original, delayed channel). In other words, the FCC media stream is positioned on a frame that has not been transmitted on the original channel stream yet.

The operation of detecting when to change back to the original TV channel, the first multicast channel, is triggered in these different ways:

According to a first alternative, a marker in FCC media stream may be provided. I.e., explicit information in the FCC media stream tells the STB that it is time to switch to the normal channel stream.

According to a second alternative, this information may be sent on the multicast control channel. The Multicast control channel described above contains information that informs the STB that it is time to switch to the normal channel stream.

According to a third alternative, the STB should switch to the original multicast channel when the FCC media stream ends. When the content of the FCC media stream disappears it implicitly tells the STB that it is time to switch to the original multicast channel. This may further be explicitly marked by an End-Of-Stream symbol.

According to a fourth alternative, the STB should change to the original multicast channel when a predefined number of frames are received such as after 3 I-frames received in the FCC media stream. The number of the predetermined frames may be sent on the multicast control channel.

When the STB switches to the original multicast channel, it leaves the FCC media stream multicast channel while (or direct following, depends on IGMP capabilities) joining the multicast channel for the original multicast channel stream.

Moreover, the STB needs to synchronize the frames between the FCC media stream and the original channel stream. Except for the synchronization activities, the possible loss of (partial) frames due to the multicast switching time may be handled as:

Accepted, i.e. the loss of frame information is accepted and the STB will have some errors in stream display. This case is an embodiment where the delay of the original channel is very small or equal to zero.

A minor delay of the original channel stream, i.e. the original channel stream is delayed a fraction of second that it will take for the STB to leave the FCC media stream and join the original channel stream.

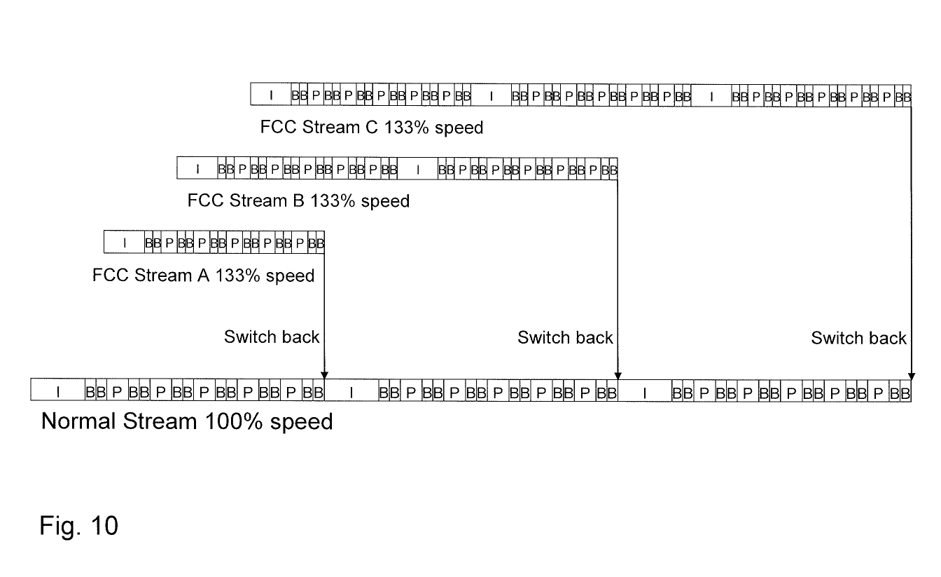

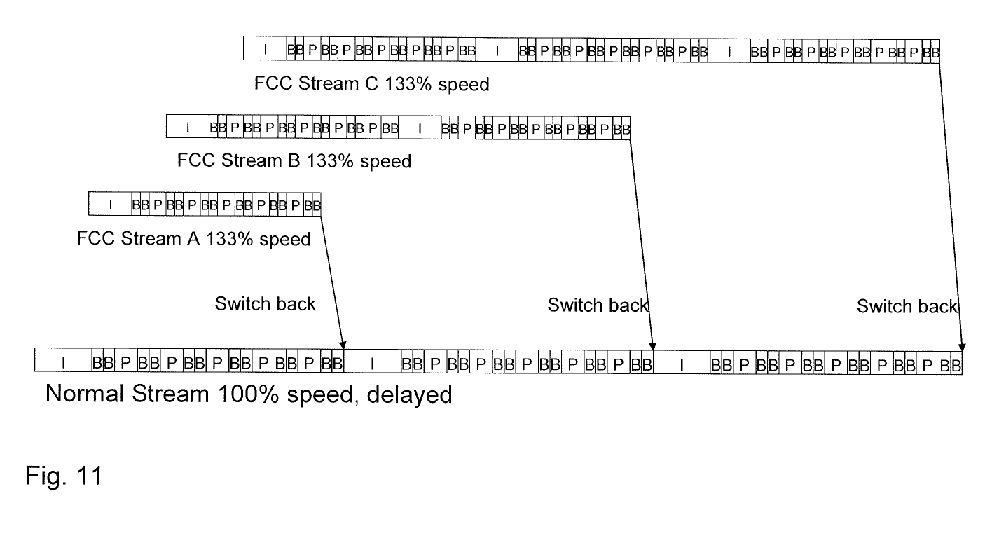

FIGS. 10 and 11 illustrate how the FCC media streams are displaced compared to the original multicast channel. In FIG. 10 the original channel is not delayed and in FIG. 11 the original channel is delayed in order to not loose any packet information in the stream.

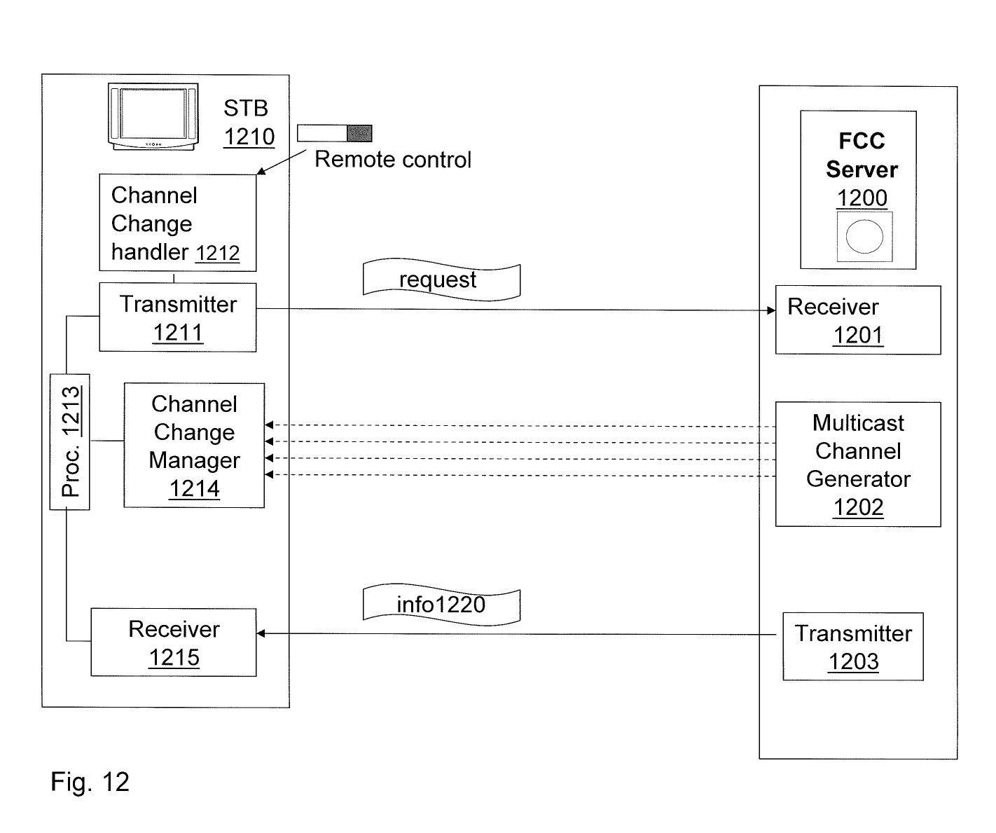

Turning now to FIG. 12, illustrating a FCC server 1200 and a STB 1210. The FCC server 1200 is a server adapted to manage fast channel change to a first multicast channel 900 requested by STB in an IPTV system. That is achieved by the FCC server and the STB by hardware or software functionality or by a combination of both. The FCC server 1200 comprises a multicast channel generator 1202 for determining to send out at least one FCC media stream multicast channel 901;902. Each FCC media stream multicast channel of the at least one FCC media stream multicast channel 901;902 is a copy of a first media stream of the first channel 900 and each FCC media stream multicast channel 901;902 is having a higher speed than the first multicast channel 900. Moreover the multicast channel generator is configured for providing the determined at least one FCC media stream multicast channel. A transmitter 1203 is also provided for sending information 1220 to the STB 1210 which FCC media stream multicast channel 902 that the STB shall join to be provided with the content of the first multicast channel 900. The transmitter may also be used for notifying the STB that the STB should switch from the FCC media stream multicast channel to the first multicast channel.

Hence the multicast generator 1202 is configured to determine how many FCC media stream multicast channels and when they should be transmitted. According to one embodiment the multicast channel generator 1202 is configured to determine to send out the at least one FCC media stream multicast channel when a receiver 1201 receives a request of channel change to the first channel. According to another embodiment, the multicast channel generator 1202 is configured to base the decision to send out at least one FCC media stream multicast channel on the number of requests for the first channel. The multicast channel generator 1202 may also be configured to determine to send out at least one FCC media stream multicast channel when at least a pre-determined number of channel change clients have requested the first channel or a predefined maximum delay is exceeded. As a further alternative, the multicast channel generator determines to send out at least one FCC media stream multicast channel when at least one STB has joined the multicast control channel. As stated above, the FCC media stream multicast channel may also be provided at regular intervals compared to a previously transmitted I-frame of the first media stream of the first multicast channel.

The STB comprises a channel change handler 1212 for determining that a change to a first multicast channel 900 is requested, a transmitter 1211 for requesting the first multicast channel 900, a receiver 1215 for receiving information 1220 of which FCC media stream multicast channel 901;902 that the STB shall join to be provided with the content of the first multicast channel 900. The STB further comprises a channel change manager 1214 for joining 304 the FCC media stream multicast channel.

The transmitter 1211 may be further configured to send a FCC request to the FCC server 1200, and a receiver 1215 is configured to receive a multicast address 1220 of the FCC media stream multicast channel 902 that the STB 1210 should join, e.g. on a multicast control channel.

Moreover, the received information 1220 may comprise a fixed scheme that the processor 1213 of the STB can use to select the FCC media stream multicast channel 902 to join. In addition, the processor 1213 may be configured to determine that the STB 1210 should switch from the joined FCC media stream multicast channel 902 to the first multicast channel 900, and the channel change manager is configured to synchronize to the first multicast channel 900.

The present invention is not limited to the above-described preferred embodiments. Various alternatives, modifications and equivalents may be used. Therefore, the above embodiments should not be taken as limiting the scope of the invention, which is defined by the appending claims.

1-39. (canceled)

40. A method in a fast channel change (FCC) server adapted to manage fast channel change to a first multicast channel requested by set-top box (STB) in an Internet Protocol Television (IPTV) system, the method comprising:
determining to send out at least one FCC media stream multicast channel, wherein each FCC media stream multicast channel comprises a copy of a first media stream of the first multicast channel, wherein each FCC media stream multicast channel having a higher speed than the first multicast channel, and wherein each FCC media stream multicast channel starts with an I-frame or S-frame;
providing the at least one FCC media stream multicast channel; and
sending information to the STB indicating to the STB which FCC media stream multicast channel to join to be provided with the content of the first multicast channel.

41. The method according to claim 40, wherein the at least one FCC media stream multicast channel comprises a time-forwarded version of the first multicast channel.

42. The method according to claim 40, further comprising receiving a request of channel change to the first multicast channel, wherein determining to send out at least one FCC media stream multicast channel comprises determining to send out the at least one FCC media stream multicast channel responsive to the received request of channel change.

43. The method according to claim 40, wherein determining to send out at least one FCC media stream multicast channel comprises determining to send out the at least one FCC media stream multicast channel based on a number of requests received for the first multicast channel.

44. The method according to claim 40, wherein determining to send out at least one FCC media stream multicast channel comprises determining to send out the at least one FCC media stream multicast channel when at least a pre-determined number of channel change clients have requested the first multicast channel or when a predefined maximum delay is exceeded.

45. The method according to claim 40, wherein sending the information comprises sending the information to the STB indicating to the STB which FCC media stream multicast channel to join via a multicast control channel.

46. The method according to claim 45, wherein determining to send out at least one FCC media stream multicast channel comprises determining to send out at least one FCC media stream multicast channel when at least one STB has joined the multicast control channel.

47. The method according to claim 40, wherein providing the at least one FCC media stream multicast channel comprises providing each FCC media stream multicast channel at regular intervals compared to a previously transmitted I-frame of the first media stream of the first multicast channel.

48. The method according to claim 47, wherein the length of the regular intervals is based on the number of STBs requesting the first multicast channel.

49. The method according to claim 40 further comprising:
notifying the STB that the STB should switch from the FCC media stream multicast channel to the first multicast channel.

50. The method according to claim 49, wherein notifying the STB comprises including a marker in the FCC media stream multicast channel.

51. The method according to claim 49, wherein notifying the STB comprises sending notification information on a multicast control channel.

52. The method according to claim 49, wherein notifying the STB comprises ending the FCC media stream multicast channel.

53. A method in a set-top-box (STB) for a fast channel change in an Internet Protocol Television (IPTV) system, the method comprising:
determining that a change to a first multicast channel is requested by a user;
sending a request to change to the first multicast channel;
receiving information indicating to the STB which fast channel change (FCC) media stream multicast channel to join to be provided with the content of the first multicast channel, wherein each FCC media stream multicast channel comprises a copy of a first media stream of the first multicast channel and has a higher speed than the first multicast channel;
joining the FCC media stream multicast channel; and
receiving an I-frame or S-frame at the start of the FCC media stream multicast channel.

54. The method according to claim 53, wherein the FCC media stream multicast channel comprises a time-forwarded version of the first media stream of the first multicast channel.

55. The method according to claim 53, wherein sending the request comprises:
sending an FCC request to a FCC server; and
receiving a multicast address for the FCC media stream multicast channel to be joined by the STB.

56. The method according to claim 55, wherein receiving the multicast address comprises receiving the multicast address on a multicast control channel.

57. The method according to claim 53, wherein receiving the information comprises receiving a fixed scheme for use by the STB in selecting the FCC media stream multicast channel.

58. The method according to claim 53, further comprising:
determining that the STB should switch from the joined FCC media stream multicast channel to the first multicast channel; and
synchronizing to the first multicast channel.

59. The method according to claim 58, wherein determining that the STB should switch comprises:
receiving switch information from the FCC server that the STB should switch from the FCC media stream multicast channel to the first multicast channel on a multicast control channel.

60. The method according to claim 59, wherein the received switch information comprises a marker in the FCC media stream multicast channel.

61. The method according to claim 59, wherein receiving switch information comprises receiving the end of the FCC media stream multicast channel implying that the STB shall synchronize to the first multicast channel.

62. The method according to claim 59, wherein receiving switch information comprises receiving a predetermined number of frames of the FCC media stream multicast channel implying that the STB shall synchronize to the first multicast channel.

63. A fast channel change (FCC) server adapted to manage fast channel change to a first multicast channel requested by set-top box (STB) in an Internet Protocol Television (IPTV) system, the FCC server comprising:
a multicast channel generator to determine to send out at least one FCC media stream multicast channel, wherein each FCC media stream multicast channel comprises a copy of a first media stream of the first multicast channel, wherein each FCC media stream multicast channel has a higher speed than the first multicast channel, and wherein each FCC media stream multicast channel starts with an I-frame or S-frame, said multicast channel generator further configured to provide the at least one FCC media stream multicast channel; and
a transmitter to send information to the STB indicating to the STB which FCC media stream multicast channel to join to be provided with the content of the first multicast channel.

64. The FCC server according to claim 63, wherein at least one of the FCC media stream multicast channels comprises a time-forwarded version of the first multicast channel.

65. The FCC server according to claim 63, further comprising a receiver to receive a request of channel change to the first multicast channel, wherein the multicast channel generator is configured to determine to send out the at least one FCC media stream multicast channel responsive to the received request of channel change to the first multicast channel.

66. The FCC server according to claim 63, wherein the multicast channel generator is configured to determine to send out at least one FCC media stream multicast channel based on a number of requests received for the first multicast channel.

67. The FCC server according to claim 63, wherein the multicast channel generator is configured to determine to send out at least one FCC media stream multicast channel when at least a pre-determined number of channel change clients have requested the first multicast channel or when a predefined maximum delay is exceeded.

68. The FCC server according to claim 63, wherein the transmitter sends the information indicating to the STB which FCC media stream multicast channel to join via a multicast control channel.

69. The FCC server according to claim 68, wherein the multicast channel generator determines to send out at least one FCC media stream multicast channel when at least one STB has joined the multicast control channel.

70. The FCC server according to claim 63, wherein the multicast channel generator provides each FCC media stream multicast channel at regular intervals compared to a previously transmitted I-frame of the first media stream of the first multicast channel.

71. The FCC server according to claim 70, wherein the length of the regular intervals is based on the number of STBs requesting the first multicast channel.

72. The FCC server according to claim 63, wherein the transmitter is further configured to notify the STB that the STB should switch from the FCC media stream multicast channel to the first multicast channel.

73. A set-top-box (STB) for a fast channel change in an Internet Protocol Television (IPTV) system comprising:
a channel change handler to determine that a change to a first multicast channel is requested by a user;
a transmitter to send a request to change to the first multicast channel;
a receiver receive information indicating which fast channel change (FCC) media stream multicast channel to join to be provided with the content of the first multicast channel, wherein each FCC media stream multicast channel comprises a copy of a first media stream of the first multicast channel and has a higher speed than the first multicast channel; and
a channel change manager configured to join the FCC media stream multicast channel, wherein the receiver is further configured to receive an I-frame or S-frame at the start of the FCC media stream multicast channel.

74. The STB according to claim 73, wherein at least one of the FCC media stream multicast channels comprises a time-forwarded version of the first media stream of the first multicast channel.

75. The STB according to claim 73, wherein the transmitter is further configured to send an FCC request to an FCC server, and the receiver is further configured to receive a multicast address of the FCC media stream multicast channel that the STB should join.

76. The STB according to claim 75, wherein the receiver receives the multicast address via a multicast control channel.

77. The STB according to claim 73, wherein the received information comprises a fixed scheme, the STB further comprising a processor configured to use the fixed scheme to select the FCC media stream multicast channel.

78. The STB according to claim 73, further comprising a processor configured to determine whether the STB should switch from the joined FCC media stream multicast channel to the first multicast channel, wherein the channel change manager is further configured to synchronize to the first multicast channel after the STB switches from the joined FCC media stream multicast channel to the first multicast channel.
